(19) United States
(12) Patent Application Publication
(10) Pub. No.: US 2003/0172904 A1
(43) Pub. Date: Sep. 18, 2003

(54) Method and device for regulating an operating variable variable of a drive unit

(76) Inventor: Mario Kustosch, Markgroeningen (DE)

Correspondence Address: Walter Ottesen, Patent Attorney, P O Box 4026, Gaithersburg, MD, 20885-4026, US

(21) Appl. No.: 10/344,256

(22) PCT Filed: Jul. 20, 2001
(86) PCT No.: PCT/DE01/02747

(30) Foreign Application Priority Data
Aug. 10, 2000 (DE) 100 38 990.2

(51) Int. Cl. F02D 41/00

(52) U.S. Cl. 123/339.21

(57) ABSTRACT

A method and an arrangement for controlling an operating variable of a drive unit is suggested. A controller is provided, which has at least one changing parameter. A switchover from a first parameter value to a second parameter value takes place in dependence upon a switchover signal. A filter is initialized with a value at the switchover time point and this value corresponds to the magnitude of the change of the output signal of the controller at this time point and, with this value, a continuous trace of the controller output signal is achieved at the switchover time point.

### STATE OF THE ART

The invention relates to a method and an arrangement for controlling an operating variable of a drive unit.

Often control systems are utilized in modern control systems for drive units of motor vehicles and these control systems control an operating variable of the drive unit to a pregiven desired value. An example of a control system of this kind are idle rpm controllers via which the rpm during idle of the drive unit is controlled to a pregiven desired value. Other examples are control systems for controlling the following: the air throughput through an internal combustion engine, the exhaust-gas composition, the torque, et cetera. DE 30 39 435 A1 (U.S. Pat. No. 4,441,471) shows an idle rpm control system wherein at least one parameter of the controller is to be variable for improving the control characteristics. In the embodiment shown, the proportional component of the controller is adapted in dependence upon the magnitude of the control deviation.

If the adaptation of the at least one controller parameter is realized as a switchover between at least two values, then an unsatisfactory switchover pressure arises which can affect the control comfort.

### ADVANTAGES OF THE INVENTION

A significant improvement of the control comfort is achieved by filtering a controller output signal during the switchover operation of at least one controller parameter between at least two values. This improvement is achieved because a switchover pressure is effectively avoided.

It is especially advantageous that the switchover takes place torque neutral, that is, no jump-like courses occur in the torque of the drive unit. A considerable improvement of driving comfort is the result. These advantages result for a proportional component as well as for a differential component of a controller.

Special advantages with a view to the driving comfort are achieved when the filter, which is used, is initialized by the controller output signal present directly in advance of the switchover.

The procedure, which is described in detail in the following, shows special advantages in the application in the context of a torque orientated engine control structure wherein the output of an idle rpm controller, the desired torque, is changed. The torque is adjusted in dependence upon this desired torque. With the use of the filter described hereinafter, a torque-neutral course of the desired torque is achieved also when switching over the controller parameter. These advantages result especially for internal combustion engines having gasoline direct injection wherein a torque-neutral course of the torque and/or of the desired torque is achieved also when there is a change of the operating mode and the switchover of the controller parameter(s) associated therewith.

Further advantages become apparent from the description of the embodiments which follows and from the dependent patent claims.

### DRAWING

The invention is explained in greater detail below based on the embodiments shown in the drawing.

FIG. 1 shows an overview block circuit diagram of a controller while, in

FIG. 2, a sequence diagram of a controller is shown with respect to the example of a proportional component which can be switched over and has filtering.

FIG. 3 shows time-dependent traces which make clear the effect of the filtering when switching over the at least one controller parameter.

### DESCRIPTION OF THE EMBODIMENTS

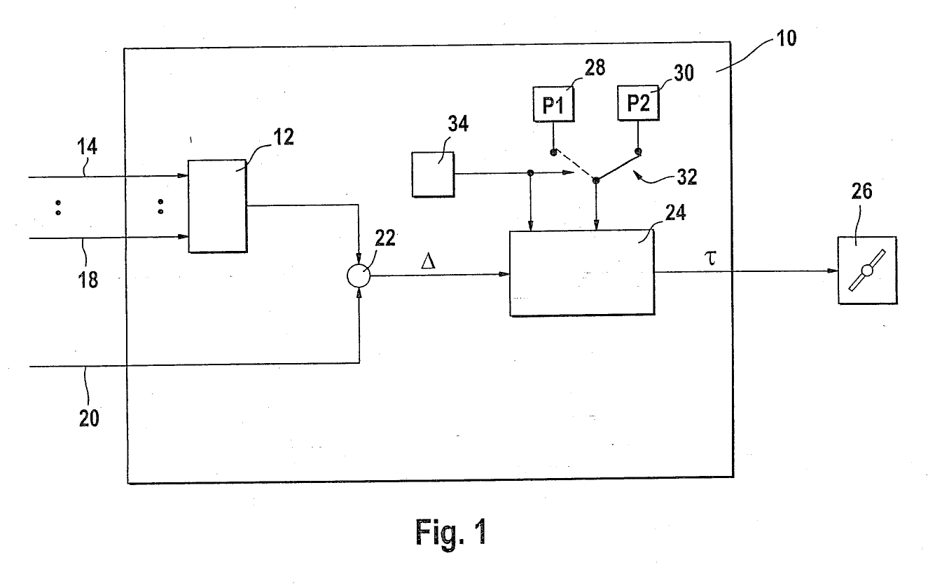

FIG. 1 shows an electronic control unit 10 for controlling a drive unit wherein a controller for controlling at least one operating variable is implemented. In the preferred embodiment, the controller is an idle rpm controller. In other embodiments, the controller can be an air throughput controller, a load controller, a torque controller, a controller of the exhaust-gas composition, et cetera. In FIG. 1, a desired value former 12 is shown which forms a desired value SOLL for the operating variable to be controlled in dependence upon at least one operating variable supplied to the control unit 10 via input lines 14 to 18. In the preferred embodiment of an idle rpm controller, the variables, which are applied for forming the desired value, are: engine temperature, the operating status of ancillary consumers such as a climate control system, et cetera. Furthermore, a signal is supplied to the control unit 10 via the input line 20. This signal is the actual quantity of the operating variable to be controlled. Desired and actual quantities are compared to each other in the comparator 22. The deviation between the desired and actual quantities is supplied to the controller 24 as control deviation Δ. This controller includes at least one changing parameter and, in the preferred embodiment, the controller comprises proportional, differential and integral components of which the proportional and/or differential components are changeable.

On the basis of the implemented control strategy, the controller 24 forms at least one output signal T in dependence upon the control deviation and this output signal T is outputted by the control unit 10 to drive an actuating member 26. In the above embodiment, each component forms a controller output signal which combined (for example, by addition) form the output signal τ. In the preferred embodiment of an idle controller, the actuating element 26 is an electrically actuable throttle flap or bypass flap which adjusts the air to the engine in such a manner that the actual value approaches the desired value. In diesel engines or in gasoline-direct injection engines, the air is not adjusted by the output signal, rather, the fuel mass so that actuating elements define actuating units for influencing the supply of fuel. Depending upon the embodiment, additional output signals can be generated, for example, for controlling the ignition angle which likewise contribute for the actual quantity to approach the desired quantity.

The different components of the controller 24 have parameters such as amplification factors whose value can be changed. In the illustrated embodiment of FIG. 1, two parameter values or parameter sets 28 and 30 are provided which are made available to the controller 24 via a switching means 32. In the preferred embodiment, the parameters which can be switched over are the amplification factor of the proportional controller and/or the amplification factor of the differential component. The switchover means 32 is switched over when the switchover condition, which is formed in 34, is present. The signal of the switching means 32 is likewise made available to the controller 24. In the preferred embodiment of an idle controller in connection with a gasoline-direct injection internal combustion engine, the switchover condition is given when the mode of operation of the engine is switched over, for example, from a homogeneous operation to an unthrottled operation or an operation with a lean mixture and vice versa. When switching over between two operating modes, there is a switchover from the first parameter of the controller to the second parameter thereof. This is so because a significant change of the characteristics of the control path (for example, dynamic performance, vibration performance, et cetera) occurs with a change of operating mode. The parameter values are adapted to the different requirements. In addition to the operating mode switchover or alternatively thereto, the parameter switchover is triggered also in dependence upon other operating states which are followed by such a change of control path, for example, when: a gear is set or disengaged, the clutch is actuated, a high power consumer is engaged, et cetera. If such an operating phase change is present, this leads to the generation of a switchover signal via the unit 34 and to a switchover of the parameter.

When switching over the parameter(s), the output of the controller changes in a jump-like manner, which is noticeable on the vehicle as a jolt. However, a continuous course of the control output is sought in order to prevent such a noticeable jolt on the vehicle. This is especially so in control systems having a torque-orientated control structure wherein the output of the idle control, inter alia, functions to correct a desired value on which the control is based (desired torque, driver command).

The fitting controller parameter(s) is selected in dependence upon the binary switchover signal. In the preferred embodiment, the parameter(s) define amplification factors with which the control deviation and/or the time-dependent change of the rpm or the control deviation is multiplied. The output signal of the controller changes in a jump-like manner when there is a switchover because, as a consequence of the change of the magnitude of the amplification parameter in the context of the multiplication, a jump-like change of the product occurs. To improve this situation, a filter is inserted which is initialized at the time point of the occurrence of the switchover signal (flank detection). The filter is preferably a lowpass filter of the first order. The initialization value of the filter is set to the value which corresponds to the difference between the controller output value before and after the switchover. In the preferred embodiment, the filter is so configured that its output signal runs exponentially toward zero after the occurrence of a switchover. The filter output value is then subtracted from the controller output so that the resulting control output signal has a continuous time-dependent course. These measures are applied to proportional components and/or differential components.

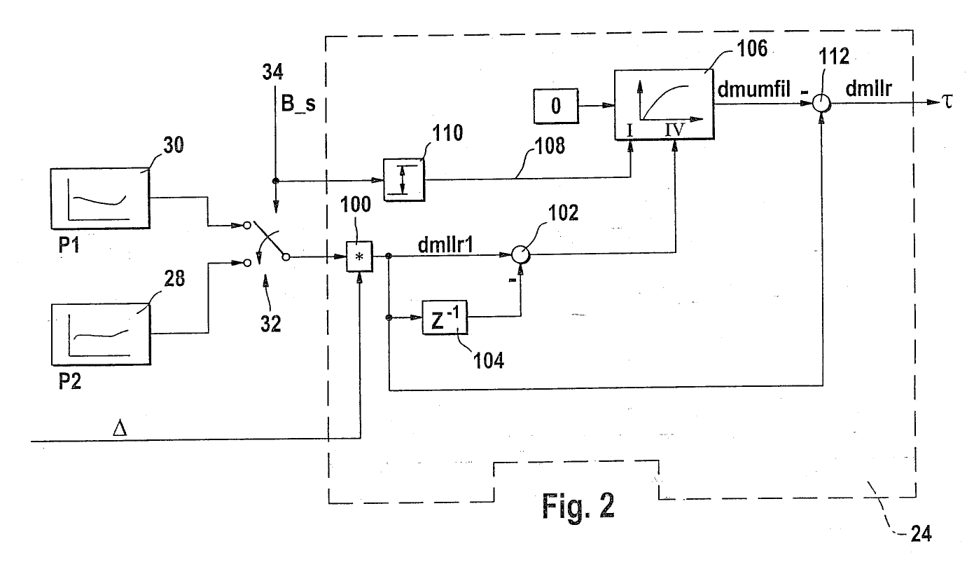

In FIG. 2, a sequence diagram is shown which makes clear the procedure described above. The sequence diagram defines a realization of the described measure as a program of the computer of the control unit 10 and describes the sequences in the controller 24 based on the example of a proportional component.

FIG. 2 shows the controller 24, to which, as shown in FIG. 1, the following are supplied: the control deviation Δ, a selected parameter (P1, P2) via the switching element 32 and the switchover signal B_s. The proportional constants (P1, P2) are selected by means of the switching element 32 and are operating-variable dependent in one embodiment (for example, on the rpm, the control deviation, et cetera). The proportional constants (P1, P2) are multiplied in the multiplier position 100 by the control deviation Δ to form an output signal dmllr1. This product shows a jump-like behavior for a switchover from the one to the other parameter. In the following subtraction position 102, the value, which is formed in the multiplier position 100, is compared to the output value (dmllr1 (z⁻¹)) which originates from the previous computation cycle. This output value is intermediately stored in a memory cell 104. The deviation between the new and the old output values is then supplied to a filter 106, especially to a lowpass filter. This filter is initialized when a flank change is present on the feed line 108. The filter has the value zero as an input value. The initialization takes place for a change of the switchover signal B_s detected in 110. If a switchover takes place from one parameter to the other parameter or vice versa, the filter is initialized by the value formed in the subtraction position 102. The signal, which is formed in the subtraction position 102, corresponds to the height of the jump with the switchover in the output signal dmllr1. At the switchover time point, the filter is therefore initialized with the value of the height of the jump. Between two switchovers, the output signal (dmumfil) of the filter runs exponentially from the initialized value toward zero. The output signal of the filter is then compared in the subtraction position 112 to the output signal dmllr1 of the multiplier stage 100 and is especially subtracted therefrom. In this way, a controller output signal dmllr arises whose trace is continuous in the switchover phase. This output signal, if required, is outputted by other controller components as drive signal T while considering the output signal.

In one embodiment, the described procedure is supplementally or alternatively applied to the differential component of the controller. The integral component is not burdened with the described problems because it has generally a non-changing output signal course.

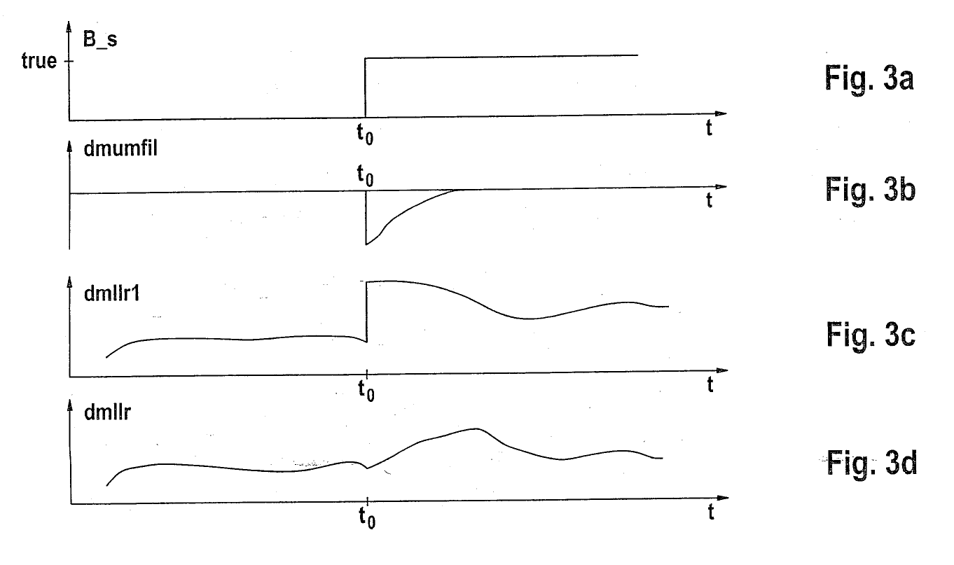

The operation of the embodiment of the controller shown in FIG. 2 is shown in FIG. 3 with the aid of time diagrams. FIG. 3a shows the time-dependent trace of the switchover signal B_s and FIG. 3b shows the output signal dmumfil of the filter. FIG. 3c shows the time-dependent trace of the output signal dmllr1 of the multiplier stage and FIG. 3d shows the time-dependent trace of the output signal dmllr of the controller or controller component.

Up to time point t0, the controller is operated with a first parameter P1. At time point t0, the parameter switchover takes place, for example, as a consequence of the change of the operating modes. Correspondingly, the switchover signal B_s is set to the value “true” in accordance with FIG. 3a. This has the consequence that at time point t0, a jump-like trace or course occurs in the output signal dmllr1 in accordance with FIG. 3c. To compensate for this jump-like trace, the filter is initialized in accordance with FIG. 3b with a value at time point t0 which corresponds to the height of the jump in the output signal of the multiplier stage. In correspondence to the filter function, the filter output signal runs from time point t0 from this value exponentially toward zero (FIG. 3b). The filter output signal is subtracted from the output signal of the multiplier stage to form the output signal dmllr. For this reason, a constant trace of the output signal results in the switchover phase in accordance with FIG. 3d.

The embodiment of FIG. 2 shows a preferred embodiment of the general solution to smooth the jump at the switchover time point with the use of a filter. The filter is initialized with the value of the height of the jump in a controller output signal when there is a parameter switchover. Other special embodiments with reference to the specific use of the filter function are conceivable in the context of this general solution and especially solutions wherein the filter is initialized at the switchover with the output signal directly ahead of the switchover. The control output signal is guided itself exponentially to the new value. The filter is not active during normal operation outside of the switchover.

1. Method for controlling an operating variable of a drive unit wherein a controller is provided which has at least one changing parameter, the controller generates an output signal in dependence upon a control deviation while considering the changing parameter, a switchover from a first parameter value to a second parameter value taking place when a switchover signal is present, characterized in that a filter is provided which is activated when there is a switchover from one parameter value to another value and is initialized with a value which effects a continuous trace of the output signal at the switchover time point.

2. Method of claim 1, characterized in that the switchover signal is formed when a change of the control path takes place, especially when: an operating mode switchover is present in an engine having gasoline-direct injection, the engagement or disengagement of a gear, the actuation of a clutch, the switching in of a consumer requiring high power.

3. Method of one of the above claims, characterized in that the at least one parameter is an amplification factor of a proportional controller and/or a constant of a differential controller.

4. Method of one of the above claims, characterized in that, for a proportional controller, the at least one changeable parameter is multiplied by the control deviation to form an output signal.

5. Method of one of the above claims, characterized in that a quantity is formed which corresponds to the height of the jump in the output signal of the controller when switching over from the first parameter value to the second parameter value.

6. Method of claim 4 or 5, characterized in that a filter is initialized with the presence of the switchover signal, the filter being initialized with the signal representing the magnitude of the jump and the output signal of the filter going exponentially toward zero starting at this time point.

7. Method of claim 4, 5 or 6, characterized in that the filter output signal is subtracted from the output signal to form a smoothed output signal.

8. Method of one of the above claims, characterized in that the controller is an idle rpm controller.

9. Method of one of the above claims, characterized in that the output signal defines the output signal of a component of the controller or the total output signal of the controller.

10. Method of one of the above claims, characterized in that the output signal of the controller is superposed on a desired value for controlling an internal combustion engine, especially a desired torque.

11. Method of one of the above claims, characterized in that, for a differential controller, the time-dependent derivative of the rpm signal and/or of the control deviation is formed with the constant which can be switched over.

12. Arrangement for controlling an operating variable of a drive unit, the arrangement including: a control unit which includes at least one controller which generates an output signal for influencing the operating variable, the controller having at least one parameter which can be switched over; and, switchover means, which switches from a first parameter value to a second parameter value when at least one switchover signal is present, characterized in that the controller includes a filter which is initialized with the presence of the switchover signal via a value which corresponds to the change of the output signal when switching over the parameter and which effects a continuous trace of the output signal of the control about the switchover time point.
